(19) United States
(12) Patent Application Publication
(10) Pub. No.: US 2026/0323350 A1
(43) Pub. Date: Oct. 15, 2026

(54) ENHANCED EVENT-TRIGGERED MEASUREMENT REPORTS

(71) Applicant: QUALCOMM Incorporated, San Diego, CA (US)

(72) Inventors: Doohyun SUNG, Basking Ridge, NJ (US); Sitaramanjaneyulu KANAMARLAPUDI, San Diego, CA (US); Jelena DAMNJANOVIC, Del Mar, CA (US)

(21) Appl. No.: 19/462,804

(22) Filed: Jan. 28, 2026

Related U.S. Application Data
(60) Provisional application No. 63/753,530, filed on Feb. 4, 2025.

(51) Int. Cl. H04W 24/10

(52) U.S. Cl. CPC H04W 24/10

(57) ABSTRACT

Methods, systems, and devices for wireless communication are described. A user equipment (UE) may detect an occurrence of an event associated with a serving beam of a serving cell or a candidate beam of a candidate cell. The UE may obtain, based on the occurrence of the event, actual measurement information indicative of at least one of: the serving beam during a first duration or the candidate beam during the first duration. The UE may transmit report information based on the occurrence of the event. The report information may include at least one of: rate of change information associated with the actual measurement information or predicted measurement information. The predicted measurement information may be indicative of at least one of: the serving beam during a second duration or the candidate beam during the second duration. The second duration may be after the first duration.

### CROSS REFERENCE

The present Application for Patent claims the benefit of U.S. Provisional Patent Application No. 63/753,530 by SUNG et al., entitled “ENHANCED EVENT-TRIGGERED MEASUREMENT REPORTS,” filed Feb. 4, 2025, and assigned to the assignee hereof. U.S. Provisional Patent Application No. 63/753,530 is expressly incorporated by reference in its entirety herein.

### INTRODUCTION

The following relates to wireless communication, including enhanced event-triggered measurement reports.

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a network entity is described. The method may include detecting an occurrence of an event associated with a serving beam of a serving cell or a candidate beam of a candidate cell, obtaining, based on the occurrence of the event, actual measurement information indicative of at least one of: the serving beam during a first duration or the candidate beam during the first duration, and transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration.

A network entity for wireless communication is described. The network entity may include a processing system. The processing system may be configured to cause the network entity to detect an occurrence of an event associated with a serving beam of a serving cell or a candidate beam of a candidate cell, obtain, based on the occurrence of the event, actual measurement information indicative of at least one of: the serving beam during a first duration or the candidate beam during the first duration, and transmit report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration.

Another network entity for wireless communication is described. The network entity may include means for detecting an occurrence of an event associated with a serving beam of a serving cell or a candidate beam of a candidate cell, means for obtaining, based on the occurrence of the event, actual measurement information indicative of at least one of: the serving beam during a first duration or the candidate beam during the first duration, and means for transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration.

A non-transitory computer-readable medium storing code for wireless communication is described. The code may include instructions executable by one or more processors to detect an occurrence of an event associated with a serving beam of a serving cell or a candidate beam of a candidate cell, obtain, based on the occurrence of the event, actual measurement information indicative of at least one of: the serving beam during a first duration or the candidate beam during the first duration, and transmit report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration.

Some examples of the method, network entities, and non-transitory computer-readable medium described herein may further include operations, features, means, or instructions for obtaining the predicted measurement information based on the actual measurement information, where the rate of change information may be based on the predicted measurement information.

Some examples of the method, network entities, and non-transitory computer-readable medium described herein may further include operations, features, means, or instructions for receiving control information that includes actual measurement control information for obtainment of the actual measurement information, predicted measurement control information for obtainment of the predicted measurement information, and an order of the rate of change information, where the order may be a derivative order.

Some examples of the method, network entities, and non-transitory computer-readable medium described herein may further include operations, features, means, or instructions for transmitting capability information that indicates a measurement capability of the network entity, where at least one of: the actual measurement control information, the predicted measurement control information, or the order of the rate of change information may be based on the capability information.

In some examples of the method, network entities, and non-transitory computer-readable medium described herein, information indicative of a quantity of actual measurements or information indicative of the first duration associated with the actual measurement information, and where the predicted measurement control information includes at least one of and information indicative of a quantity of predicted measurements or information indicative of the second duration associated with the predicted measurement information.

Some examples of the method, network entities, and non-transitory computer-readable medium described herein may further include operations, features, means, or instructions for obtaining, during the second duration, additional actual measurement information indicative of at least on of: the serving beam during the first duration or the candidate beam during the first duration and updating at least one of: actual measurement control information for obtainment of second actual measurement information, predicted measurement control information for obtainment of second predicted measurement information, or an order of the rate of change information based on a difference between the additional actual measurement information and the predicted measurement information.

Some examples of the method, network entities, and non-transitory computer-readable medium described herein may further include operations, features, means, or instructions for receiving control information that indicates at least one of: a first scaling factor associated with the actual measurement information or a second scaling factor associated with the predicted measurement information, where the rate of change information may be based on at least one of: the first scaling factor or the second scaling factor.

In some examples of the method, network entities, and non-transitory computer-readable medium described herein, obtaining the actual measurement information may include operations, features, means, or instructions for performing one or more actual measurements via one or more measurement resources.

In some examples of the method, network entities, and non-transitory computer-readable medium described herein, obtaining the actual measurement information may include operations, features, means, or instructions for performing one or more actual measurements via one or more data resources.

In some examples of the method, network entities, and non-transitory computer-readable medium described herein, and the method, apparatuses, and non-transitory computer-readable medium may include further operations, features, means, or instructions for an identifier associated with the serving beam or the candidate beam, a predicted timing associated with the predicted measurement information, or a confidence level associated with the predicted measurement information.

In some examples of the method, network entities, and non-transitory computer-readable medium described herein, the rate of change information may include operations, features, means, or instructions for a derivative value associated with the actual measurement information or the predicted measurement information, and an order of a derivative associated with the derivative value.

In some examples of the method, network entities, and non-transitory computer-readable medium described herein, the report information includes the actual measurement information, the predicted measurement information, and the rate of change information associated with the serving beam or the candidate beam based on the rate of change information being indicative of a positive rate of change over the second duration.

In some examples of the method, network entities, and non-transitory computer-readable medium described herein, the report information excludes second actual measurement information, second predicted measurement information, and second rate of change information associated with a second candidate beam based on the second rate of change information being indicative of a negative rate of change over the second duration.

A method for wireless communication by a first network entity for wireless communication is described. The method may include receiving report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration and transmitting mobility information to the second network entity, where the mobility information is based on the rate of change information.

A first network entity for wireless communication for wireless communication is described. The first network entity for wireless communication may include a processing system. The processing system may be configured to cause the first network entity for wireless communication to receive report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration and transmit mobility information to the second network entity, where the mobility information is based on the rate of change information.

Another first network entity for wireless communication for wireless communication is described. The first network entity for wireless communication may include means for receiving report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration and means for transmitting mobility information to the second network entity, where the mobility information is based on the rate of change information.

A non-transitory computer-readable medium storing code for wireless communication is described. The code may include instructions executable by one or more processors to receive report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration and transmit mobility information to the second network entity, where the mobility information is based on the rate of change information.

Some examples of the method, first network entity for wireless communication, and non-transitory computer-readable medium described herein may further include operations, features, means, or instructions for communicating with the second network entity via the candidate beam based on the rate of change information, where the mobility information indicates the candidate beam as an active beam.

Some examples of the method, first network entity for wireless communication, and non-transitory computer-readable medium described herein may further include operations, features, means, or instructions for performing a handover procedure for the second network entity based on the rate of change information, where the mobility information indicates the handover procedure.

Some examples of the method, first network entity for wireless communication, and non-transitory computer-readable medium described herein may further include operations, features, means, or instructions for transmitting control information that includes actual measurement control information for obtainment of the actual measurement information, predicted measurement control information for obtainment of the predicted measurement information, and an order of the rate of change information, where the order may be a derivative order.

Some examples of the method, first network entity for wireless communication, and non-transitory computer-readable medium described herein may further include operations, features, means, or instructions for receiving capability information that indicates a measurement capability of the second network entity, where at least one of: the actual measurement control information, the predicted measurement control information, or the order of the rate of change information may be based on the capability information.

In some examples of the method, first network entity for wireless communication, and non-transitory computer-readable medium described herein, information indicative of a quantity of actual measurements or information indicative of the first duration associated with the actual measurement information, and where the predicted measurement control information includes at least one of and information indicative of a quantity of predicted measurements or information indicative of the second duration associated with the predicted measurement information.

Some examples of the method, first network entity for wireless communication, and non-transitory computer-readable medium described herein may further include operations, features, means, or instructions for transmitting control information that indicates at least one of: a first scaling factor associated with the actual measurement information, a second scaling factor associated with the predicted measurement information, where the rate of change information may be based on at least one of: the first scaling factor or the second scaling factor.

In some examples of the method, first network entity for wireless communication, and non-transitory computer-readable medium described herein, and the method, apparatuses, and non-transitory computer-readable medium may include further operations, features, means, or instructions for an identifier associated with the serving beam or the candidate beam, a predicted timing associated with the predicted measurement information, or a confidence level associated with the predicted measurement information.

In some examples of the method, first network entity for wireless communication, and non-transitory computer-readable medium described herein, the rate of change information may include operations, features, means, or instructions for a derivative value associated with the actual measurement information or the predicted measurement information, and an order of a derivative associated with the derivative value.

In some examples of the method, first network entity for wireless communication, and non-transitory computer-readable medium described herein, the report information includes the actual measurement information, the predicted measurement information, and the rate of change information associated with the serving beam or the candidate beam based on the rate of change information being indicative of a positive rate of change over the second duration.

In some examples of the method, first network entity for wireless communication, and non-transitory computer-readable medium described herein, the report information excludes second actual measurement information, second predicted measurement information, and second rate of change information associated with a second candidate beam based on the second rate of change information being indicative of a negative rate of change over the second duration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communication system that supports enhanced event-triggered measurement reports in accordance with one or more aspects of the present disclosure.

FIG. 2 shows an example of a wireless communication system that supports enhanced event-triggered measurement reports in accordance with one or more aspects of the present disclosure.

FIG. 3 shows an example of measurement timelines that supports enhanced event-triggered measurement reports in accordance with one or more aspects of the present disclosure.

FIG. 4 shows an example of a process flow that supports enhanced event-triggered measurement reports in accordance with one or more aspects of the present disclosure.

FIGS. 5 and 6 show block diagrams of devices that support enhanced event-triggered measurement reports in accordance with one or more aspects of the present disclosure.

FIG. 7 shows a block diagram of a communications manager that supports enhanced event-triggered measurement reports in accordance with one or more aspects of the present disclosure.

FIG. 8 shows a diagram of a system including a device that supports enhanced event-triggered measurement reports in accordance with one or more aspects of the present disclosure.

FIGS. 9 and 10 show block diagrams of devices that support enhanced event-triggered measurement reports in accordance with one or more aspects of the present disclosure.

FIG. 11 shows a block diagram of a communications manager that supports enhanced event-triggered measurement reports in accordance with one or more aspects of the present disclosure.

FIG. 12 shows a diagram of a system including a device that supports enhanced event-triggered measurement reports in accordance with one or more aspects of the present disclosure.

FIGS. 13 through 17 show flowcharts illustrating methods that support enhanced event-triggered measurement reports in accordance with one or more aspects of the present disclosure.

### DETAILED DESCRIPTION

In some wireless communication systems, a user equipment (UE) may participate in lower-layer triggered mobility (LTM) based on a first channel quality of a serving beam or serving cell and a second channel quality of a candidate beam or serving cell. In some examples (e.g., as part of the LTM), the UE may transmit measurement information (e.g., a measurement report) based on an occurrence of one or more events (e.g., LTM events). For example, the UE may transmit measurement information based on the second channel quality being more reliable than the first channel quality. The measurement information may include one or more first measurements performed on the candidate beam during a first duration and one or more second measurements performed on the serving beam during the first duration. A network entity may determine to switch an active beam from the serving beam to the candidate beam based on the one or more second measurements indicating a better channel quality than the one or more first measurements.

However, the second channel quality of the candidate beam may be deteriorating. For example, a rate of change (e.g., slope or any order derivative) of the one or more second measurements associated with the candidate beam may be negative, indicating that the second channel quality may be deteriorating. In parallel, a rate of change of the one or more first measurements associated with the serving beam may be positive, indicating that the first channel quality is improving. During a second duration subsequent to the first duration, the first channel quality may be more reliable than the second channel quality based on the rate of change despite the one or more second measurements indicating more reliable channel quality during the first duration compared to the one or more first measurements. Switching the active beam to a candidate beam with deteriorating channel quality may decrease communication efficiency and reliability.

According to techniques described herein, the UE may include rate of change information in the measurement information. For example, the UE may detect an occurrence of an event (e.g., an LTM event) associated with the serving beam or the candidate beam. The UE may perform, during the first duration and based on the occurrence of the event, one or more first measurements indicative of the first channel quality of the serving beam and one or more second measurements indicative of the second channel quality of the candidate beam. The UE may transmit the measurement information based on the occurrence of the event. The measurement information may include first rate of change information associated with the one or more first measurements and second rate of change information associated with the one or more second measurements. The network entity may determine whether to perform a beam switch or handover procedure based on the one or more first measurements, the one or more second measurements, and the rate of change information. For example, the network entity may determine not to switch an active beam from the serving beam to the candidate beam based on the serving beam being associated with a positive rate of change and the candidate beam being associated with a negative rate of change. Indicating the rate of change information to the network entity may increase communications efficiency and reliability.

Aspects of the disclosure are initially described in the context of wireless communication systems. Additional aspects of the disclosure are described in the context of measurement timelines and process flows. Aspects of the disclosure are further illustrated by and described with reference to apparatus diagrams, system diagrams, and flowcharts that relate to enhanced event-triggered measurement reports.

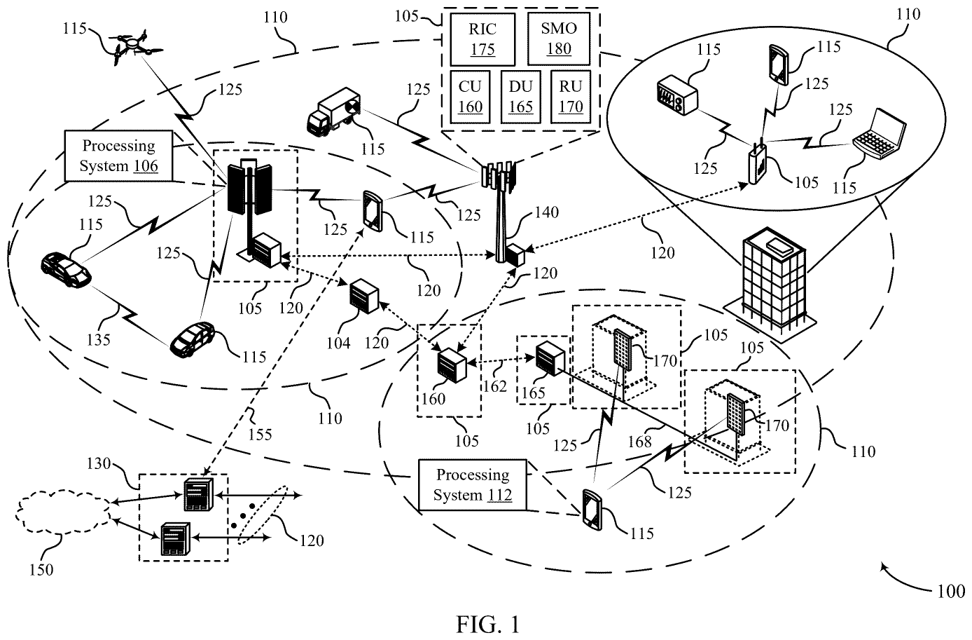

FIG. 1 shows an example of a wireless communication system 100 that supports enhanced event-triggered measurement reports in accordance with one or more aspects of the present disclosure. The wireless communication system 100 may include one or more devices, such as one or more network devices (e.g., network entities 105), one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified nouns in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communication system 100 (e.g., other wireless communication devices, including UEs 115 or network entities 105), as shown in FIG. 1.

As described herein, a node of the wireless communication system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communication systems (e.g., the wireless communication system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support enhanced event-triggered measurement reports as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communication resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(ΔfₘₐₓN_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems, such as the wireless communication system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communication system 100 may include, for example, a heterogeneous network in which different types of the network entities 105 support communications for coverage areas 110 (e.g., different coverage areas) using the same or different RATs.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

According to techniques described herein, the UE 115 may include rate of change information in the measurement information. For example, the UE 115 may detect an occurrence of an event (e.g., an LTM event) associated with the serving beam or the candidate beam. The UE 115 may perform, during the first duration and based on the occurrence of the event, one or more first measurements indicative of the first channel conditions of the serving beam and one or more second measurements indicative of the second channel conditions of the candidate beam. The UE 115 may transmit measurement information via the measurement information based on the occurrence of the event. The measurement information may include first rate of change information associated with the one or more first measurements and second rate of change information associated with the one or more second measurements. The network entity 105 may determine whether to perform a beam switch or handover procedure based on the one or more first measurements, the one or more second measurements, and the rate of change information. For example, the network entity 105 may determine not to switch an active beam from the serving beam to the candidate beam based on the serving beam being associated with a positive rate of change and the candidate beam being associated with a negative rate of change. Indicating the rate of change information to the network entity 105 may increase communications efficiency and reliability.

In some examples, the measurement information may provide measurement related enhancements for supporting LTM. For example, the measurement related enhancements may be applicable to intra-CU master cell group (MCG) LTM, intra-CU secondary cell group (SCG) LTM, inter-CU MCG LTM, or inter-CU SCG LTM. The measurement information may include components to support event triggered L1 measurement reporting. Event triggered measurements may be associated with MIMO handover or mobility procedures. The measurement information may include CSI-RS measurements for LTM procedures, and the measurement information may enable CSI-RS based beam management or physical layer operations on candidate cells before LTM. The UE may perform CSI acquisition on one or more candidate cells based on the CSI-RS before or during LTM cell switch. The UE 115 may transmit CSI reports before or during the LTM cell switch, as part of the CSI acquisition procedure.

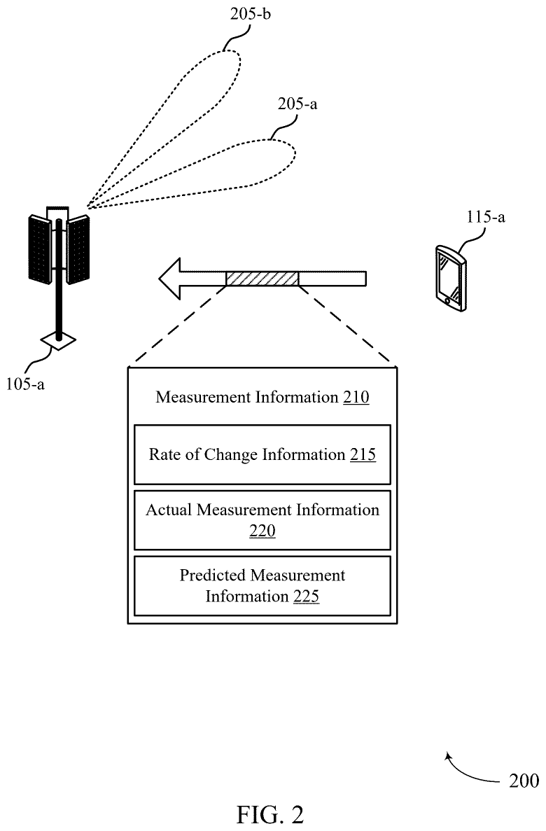

FIG. 2 shows an example of a wireless communication system 200 that supports enhanced event-triggered measurement reports in accordance with one or more aspects of the present disclosure. In some examples, wireless communication system 200 may implement aspects of wireless communication system 100. For example, a UE 115-a may represent an example of a UE, such as the UEs 115 described with reference to FIG. 1. A network entity 105-a may represent an example of a network entity, such as the network entities 105 described with reference to FIG. 1. The UE 115-a may transmit measurement information 210 (e.g., a measurement report) to the network entity 105-a.

The network entity 105-a may perform a beam switch procedure or a handover procedure based on the measurement information 210. The network entity 105-a may communicate with the UE 115-a via one or more beams 205. The one or more beams may include a serving beam 205-a and a candidate beam 205-b. In some cases, the serving beam 205-a and the candidate beam 205-b may be utilized by a same cell. In some cases, the serving beam 205-a may be utilized by a serving cell and the candidate beam 205-b may be utilized by a candidate cell.

In some wireless communication systems, the UE 115-a may perform LTM based on a first channel quality of the serving beam 205-a and second channel quality of the candidate beam 205-b. In some examples, (e.g., as part of the LTM), the UE 115-a may transmit the measurement information based on an occurrence of one or more events (e.g., LTM events). For example, the UE 115-a may measure first channel quality for the serving beam 205-a, and the UE 115-a may measure a second channel quality for the candidate beam 205-b. The UE 115-a may transmit the measurement information 210 based on measuring first channel quality as being more reliable than the first channel quality. The measurement information 210 may be an example of an event-triggered (e.g., L1 event-triggered) or event driven measurement report (e.g., for LTM).

In some examples, the network entity 105-a may transmit an LTM configuration to the UE 115-a. The LTM configuration may configure event-triggered L1 measurement reports for LTM. As part of the LTM procedure, the UE 115-a or the network entity 105-a may select a candidate beam 205-b or a candidate cell to trigger early synchronization, and the UE 115-a or the network entity 105-a may select a target beam or a target cell and trigger an LTM cell switch procedure. For event-triggered L1 measurements, the UE 115-a may use beam level measurement results for event evaluation of the one or more LTM events. The beam level measurement results may be a baseline for the event evaluation for beam mobility, and the cell level measurement results may be a baseline for event evaluation for cell mobility.

The one or more events (e.g., the LTM events) may be based on a beam specific quality of a serving cell and one or more candidate cells. For example, the LTM events may be based on the first channel quality of the serving beam 205-a and the second channel quality of the candidate beam 205-b. In some examples, the one or more LTM events may include an event (e.g., LTM2 event) where a channel quality of a beam of a serving cell (e.g., the serving beam 205-a) becomes less than a threshold (e.g., an absolute threshold). In some examples, the one or more LTM events may include an event (e.g., LTM3 event) where a channel quality for a beam of a candidate cell (e.g., the candidate beam 205-b) becoming an amount (e.g., an amount of offset) greater than a channel quality for the beam of the serving cell. In some examples, the one or more LTM events may include an event (e.g., LTM4 event) where a channel quality of a beam of a candidate cell satisfies a threshold. In some examples, the one or more LTM events may include an event (e.g., LTM5 event) where a channel quality of a beam of a serving cell becomes less than a first threshold and a channel quality of a beam of a candidate cell becomes satisfies a second threshold. In some cases, one or more beams of a servicing cell or one or more beams of a candidate cell may be used for event evaluation.

The LTM configuration may support beam configurations of both synchronization signal blocks (SSBs) and CSI-RSs in an L1 measurement resource configuration. A same reference signal type may be used for both the serving beam 205-a or a serving cell and a candidate beam 205-b or a candidate cell (e.g., neighboring cell) for at least some of the one or more LTM events (e.g., in the LTM3 event and the LTM5 event). The network entity 105-a may configure which reference signal type (e.g., SSB or CSI-RS) is used for event evaluation (e.g., LTM event evaluation). Either CSI-RS or SSB may be configured as a candidate beam and the measurement reference signal of the serving beam 205-a may be determined based on the candidate beam to ensure a same reference signal type. For example, the reference signal for a current beam of a serving cell may be the same as or quasi-collocated (QCL) with a QCL reference signal of the indicated transmission configuration indication (TCI) state.

SSB resource indicator (RI) and CSI-RS RI (CRI) may be used to represent the candidate beam identifier for a MAC-CE (e.g., an LTM measurement report MAC-CE). A single MAC control element (MAC-CE) format for the event-triggered L1 measurement report may be used for both the SSB and CSI-RS reference signals.

For event evaluation (e.g., LTM event evaluation), a time to target (TTT), a hysteresis for entering or leaving, or a beam specific or cell specific offset may be applied. For example, the UE 115-a may evaluate one or more entering or leaving conditions as part of an LTM event. Once conditions for the LTM event evaluation are met, measurement reporting may continue or be halted. In some examples, a TTT may be evaluated per beam, and a measurement report may be triggered by a beam that has satisfied the condition (e.g., by the entering condition or the leaving conditions) for a whole duration of TTT. TTT operates based on a timer (e.g., similar to TTT used in layer three (L3) event triggered measurement reports). In some examples, a TTT timer may not be restarted if a current beam changes and an entering condition is still met with the new current beam. In some examples, a TTT may be applied to the leaving condition. The entire event evaluation procedure may be handled by a MAC layer based on latest L1 measured results reported by a physical layer.

In some examples, the UE 115-a may perform filtering of the L1 measure results (e.g., for MIMO handover). In some examples, the LTM configuration may not indicate whether the UE 115-a is to perform filtering of the L1 measurement results. Whether the UE 115-a performs a specified L1 filtering may be based on (e.g., left to) a UE implementation of the UE 115-a.

The UE 115-a may transmit the event-triggered L1 measurement report (e.g., the measurement information 210) for LTM to the network entity 105-a and via a MAC-CE. In some cases, the MAC-CE may include a limited amount of information. For example, for event-triggered L1 LTM measurement reporting, the measurement information may include a threshold (e.g., maximum) quantity N of beams included into a MAC-CE. For event-triggered L1 LTM measurement reporting, the network entity 105-a may indicate (e.g., control) if one or more beams not satisfying the event may be reported according to the N beams in the MAC CE. The UE 115-a may truncate the measurement information 210 to transmit the measurement information 210 via the MAC-CE.

The network entity 105-a may configure the UE 115-a with one or more entering conditions and one or more leaving conditions. The UE 115-a may transmit the measurement information 210 based on a leaving condition being met (e.g., based on the one or more leaving conditions configured by the network entity 105-a). The network entity 105-a may configure the UE 115-a to transmit event triggered periodic measurement reports.

The network entity 105-a may transmit a measurement resource configuration to the UE 115-a. The UE 115-a may perform one or more measurement to obtain the measurement information in accordance with the measurement resource configuration. In some examples, the measurement resource configuration may be an LTM CSI resource configuration. The measurement resource configuration may include an indication that the measurement resource configuration includes CSI-RS resources.

The network entity 105-a may transmit a measurement reporting configuration to the UE 115-a. In some examples, the measurement report configuration may be an LTM CSI report configuration (e.g., LTM-CSI-ReportConfig). For association between measurement resource configuration and measurement reporting configuration the UE may utilize the LTM configuration.

The measurement information 210 (e.g., MAC CE measurement report) may include one or more parameters. The measurement information 210 may include beam information. In some examples, the beam information may include an SSBRI or CRI for the beams included in the measurement information (e.g., the N beams). In some examples, the beam information may include an LTM configuration identifier and an SSB identifier or a CSI-RS identifier. The measurement information 210 may include one or more measurement samples (e.g., a beam quantity) such as an L1-RSRP measurement or a SINR measurement of the beams (e.g., the N beams). The one or more measurement samples may be a filtered L1-RSRP or an unfiltered L1-RSRP which may indicate a snapshot of measurement results. The measurement information 210 may include an indication of the event (e.g., the LTM event) that trigged the measurement information 210. For example, the measurement information 210 may include triggered event information (e.g., ReportConfigID). The measurement information 210 may include information for up to N beams. In some cases, the N beam may satisfy the LTM event. In some cases, at least some of the N beams may not satisfy the LTM event. The quantity N may be indicated by the network entity 105-a (e.g., as part of the LTM configuration).

The measurement information 210 may include information and measurement samples (e.g., quantity) of a current beam (e.g., the serving beam 205-a). The measurement information 210 may include the information of the current beam based on an indication from the network entity 105-a (e.g., included in the LTM configuration).

In some examples, a schedule request procedure for resource allocation may be utilized to send the measurement information 210 (e.g., the event-triggered L1 measurements MAC CE). In some examples, the network entity 105-a may configure a dedicated schedule request configuration for transmission of the measurement information.

In wireless communication systems, a beam or cell level measurement report (e.g., an L1 measurement report L1 or an L3 measurement report) may include one or more measurement samples (e.g., report metrics). The measurement samples may represent a snapshot of measurements at a time. The measurements may be filtered or unfiltered by the UE 115-a. In order for the network entity 105-a to know rate of change information (e.g., a trend) of the measurement results, the network entity 105-a may utilize multiple measurement reports. The rate of change information may indicate a high or a low slope. The high or low slope may indicate quickly or slowly increasing or decreasing a channel quality associated with a beam or cell.

The UE 115-a may be configured to transmit the measurement information (e.g., trigger the measurement reports) as frequently as possible to provide rate of change information to the network entity 105-a. However, the frequent measurement reports may reduce or degrade throughput due to interruptions. In some cases, the measurement reports may be inter-frequency measurements.

In some examples, (e.g., LTM), the network entity 105-a may track a beam associated with a highest channel quality from a candidate cell. The network entity 105-a may utilize the beam associated with the highest channel quality to reduce a cell switch latency. For example, for event-triggered L1 measurement reports for LTM, the UE 115-a may report beam information that may be expected to be associated with a high channel quality or valid beam information. For example, the beam information may be expected to have a high channel quality or be valid in the near future (e.g., when LTM is triggered). The beam information may be beneficial when an event is triggered.

According to techniques described herein, the measurement information 210 (e.g., event-triggered L1 measurement report for LTM) may include rate of change information 215. For example, the UE 115-a may derive rate of change information (e.g., trend information) based on historical measurements or predicted measurements (e.g., predicted inference results). The UE 115-a may include the rate of change information 215, actual measurement information 220, and predicted measurement information 225 in the measurement information 210, and the network entity 105-a may determine which beam is suitable for an LTM switch with a single transmission of measurement information 210 (e.g., a single measurement report).

The UE 115-a may include actual measurement information 220 and predicted measurement information 225 in the measurement information 210. The actual measurement information 220 may include one or more measurement samples (e.g., L1-RSRP or L1-SINR) of a channel quality performed on one or more beams (e.g., the serving beam 205-a and the candidate beam 205-b). The predicted measurement information 225 may include one or more estimations or predictions for the channel quality performed on the one or more beams. Along with the actual measurement information 220 and the predicted measurement information 225 (e.g., report metric values), the UE 115-a may include rate of change information 215 (e.g., trend information) of the measurement samples. The rate of change information 215 may indicate how fast a channel quality is varying over time. For example, a high rate of change (e.g., a high slope) may indicate that the channel quality is increases or degrading quickly.

The rate of change information 215 may be used to prioritize the beam information to be reported. For example, the UE 115-a may prioritize beams to be included in the measurement information 210 based on the rate of change information 215 measured for the beams. Additionally, or alternatively, the UE 115-a may prioritize beams to be included in the measurement information 210 based on actual measurement information 220 or predicted measurement information 225 (e.g., report metric value) performed on the beams.

The rate of change information (e.g., the trend of measurement samples) may be the L^{th} derivative from a latest M measurement samples or N predicted (e.g., inference) samples. The UE 115-a may measure the latest M measurement samples and the UE 115-a may predict the predicted samples during a first duration. The predicted samples may predict channel conditions during a second duration after the first duration. For example, the second duration may be after transmission of the measurement information 210 or after performance of one or more actual measurements (e.g., in the future).

If the N is set to zero, the UE 115-a may predict the rate of change of the measurement samples during the second duration based on the latest M measurement samples (e.g., the UE may calculate a direct prediction of the L^{th} derivative).

The values of L, M, or N may be configured by the network entity 105-a, preconfigured at the UE 115-a, or autonomously selected by the UE 115-a. The network entity 105-a may configure the values of L, M, or N via semi-static RRC signaling or dynamic MAC CE signaling. The UE 115-a may transmit capability information (e.g., as part of a capability exchange). The network entity 105-a may set the values of L, M, or N based on the capability exchange.

The UE 115-a may adjust the values of L, M, or N based on observations. In some examples, the UE 115-a may adjust the values of L, M, or N based on measurement results, prediction results, or an accuracy of previous rate of change information (e.g., trend information). For example, if the UE 115-a observes that a difference between one or more actual measurement samples and measurement samples estimated by a previous rate of change satisfies a threshold, the UE 115-a may adjust the values of L, M, or N. Although the values of M and N are initially described in the context of a quantity of measurement samples, the values of M and N may represent a time window (e.g., in seconds, milliseconds (ms), microseconds, or OFDM symbols).

The UE 115-a may determine the rate of change information 215 in accordance with one or more scaling factors (e.g., weights). The one or more scaling factors may be defined for one or more samples or a range within the time window (e.g., measured or predicted) when deriving the rate of change information 215 (e.g., derivative). For example, a first scaling factor may be applied to the M measurement samples and a second scaling factor may be applied to the N measurement samples. In some examples, the network entity 105-a may configure the one or more scaling factors. In some examples, the one or more scaling factors may be preconfigured at the UE 115-a, or the one or more scaling factors may be based on a UE implementation.

The measurement samples may be obtained either from measurement resource (e.g., SSB or CSI-RS) or from data resource (DM-RS). The network entity 105-a may configure the UE 115-a to allow, disallow, or switch between measurement resource and data resource.

The UE 115-a may include one or more of the derivative outcome, the value of L, the predicted timing for the derivative, and a confidence level (e.g., if prediction measurement samples are used to determine the rate of change information 215) into the measurement information 210 (e.g., MAC CE measurement report).

The measurement information 210 may include beam level report contents for each beam reported by the measurement information 210. The beam level report contents may be repeated if there are multiple beams. For example, measurement information 210 may include a beam identifier, the beam measurement results (e.g., measurement quantity), and an indication of whether measurement samples included in the measurement information 210 are filtered values over time or instantaneous values. The measurement information 210 may further rate include a derivative value, a value L used for the derivative, a predicted timing associated with the rate of change information 215, and a confidence level for the rate of change information 215.

The rate of change information 215 (e.g., the derivative outcome) may be used to prioritize a triggered event or beam to be reported in the measurement information 210. The UE 115-a may prioritize one or more beams when the measurement information 210 (e.g., measurement report MAC CE) is truncated due to insufficient payload size. For example, one or more events that have the beams with a positive trend (e.g., a channel metric is expected to indicate an improved channel quality) may be prioritized over the events that do not have those beams. Within the one or more events, the beams with a positive trend may be prioritized over the beams that do not have a positive trend.

In some examples, the measurement information 210 may not include the rate of change information 215 (e.g., derivative information). The network entity 105-a may assume that beam level report contents included in the measurement information 210 have a positive trend for the rate of change information 215.

Although initially described in the context of event triggered L1 measurement reports for LTM, the measurement information 210 may be an example of an L1 network entity scheduled CSI reports (e.g., a periodic, semi-persistent, aperiodic, or event-triggered CSI report) or an L3 measurement reports (e.g., a periodic or event-triggered L3 measurement report).

In some cases, the network entity 105-a may configure the UE 115-a to report more than one derivative information. For example, the rate for change information 215 may include derivative values for a first derivate of a first order and a second derivate of a second order.

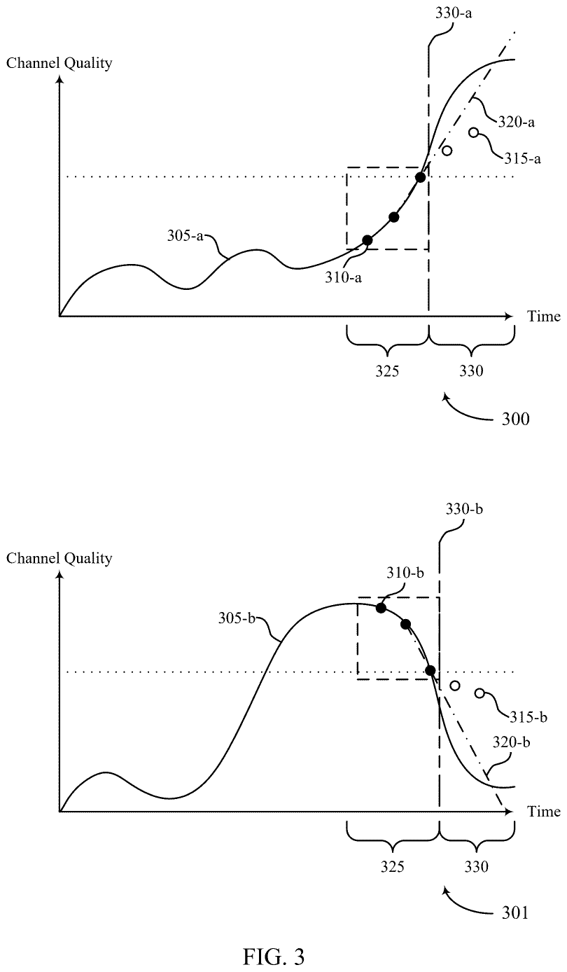

FIG. 3 shows an example of a first measurement timeline 300 and a second measurement timeline 301 that supports enhanced event-triggered measurement reports in accordance with one or more aspects of the present disclosure. In some examples, the measurement timeline 300 may implement aspects of wireless communication system 100 and wireless communication system 200. For example, the first measurement timeline 300 may be implemented by a UE such as a UE 115, as described with reference to FIGS. 1 and 2. The UE 115 may perform one or more actual measurement samples 310, and the UE 115 may determine one or more predicted measurement samples 315. The UE 115 may determine rate of change information based on the one or more actual measurement samples 310 and the one or more predicted measurement samples 315.

A channel quality 305 of beam or cell may fluctuate over time. For example, a first channel quality 305-a in the first measurement timeline 300 may represent the channel quality of a first beam or a first cell (e.g., a serving beam or a serving cell), and a second channel quality 305-b may represent the channel quality of a second beam or second cell (e.g., a candidate beam or a candidate cell).

As illustrated in FIG. 3, the UE 115 may determine rate of change information (e.g., a slope 320) based on three actual measurement sample and two predicted measurement samples (e.g., M=3, N=2, and L=1). In some cases, the UE 115 may determine the rate of change information without predicted measurement samples (e.g., N=0).

The UE 115 may perform, during a first duration 325, one or more actual measurements to obtain the one or more actual measurement samples 315. The one or more actual measurement samples 315 may indicate a channel quality 305 during the first duration 325. In some cases, the first duration may be an example of a TTT. The UE 115-a may determine, during a second duration 330, one or more predicted measurement samples 315-b. The one or more predicted measurement samples 315 may estimate a channel quality 305 over the second duration 330.

In some examples (e.g., if L=1), the UE 115 may determine a slope 320-a based on the one or more actual measurement samples 310-a and one or more predicted measurement samples 315-a, and the UE 115 may determine a slope 320-b based on the one or more actual measurement samples 310-b and the one or more predicted measurement samples 315-b. The slope 320-a may be a positive slope (e.g., a medium positive slope), and the slope 320-b may be a negative slope (e.g., a high negative slope). The positive slope 320-a may indicate that the first beam or the first cell may be a candidate for a cell switch. The negative slope 320-b may indicate that the second beam or the second cell may be a bad candidate for a cell switch.

As illustrated in the first measurement timeline 300, the UE 115 may transmit measurement information at 330-a. As illustrated in the second measurement timeline 301, the UE 115 may transmit measurement information at 330-b. In some cases, the measurement information may include a single most recent actual measurement sample 310.

In some examples, the UE 115 may report similar actual measurement samples 310 or similar predicted measurement samples 315 for the first beam or first cell and the second beam or second cell. For beams or cells with similar actual measurement samples 310 or similar predicted measurement samples 315, the network entity 105 may utilize the slope information to distinguish different beams or cells. For example, the network entity may switch to the first beam or the first cell based on the slope 320-a being positive and the slope 320-b being negative.

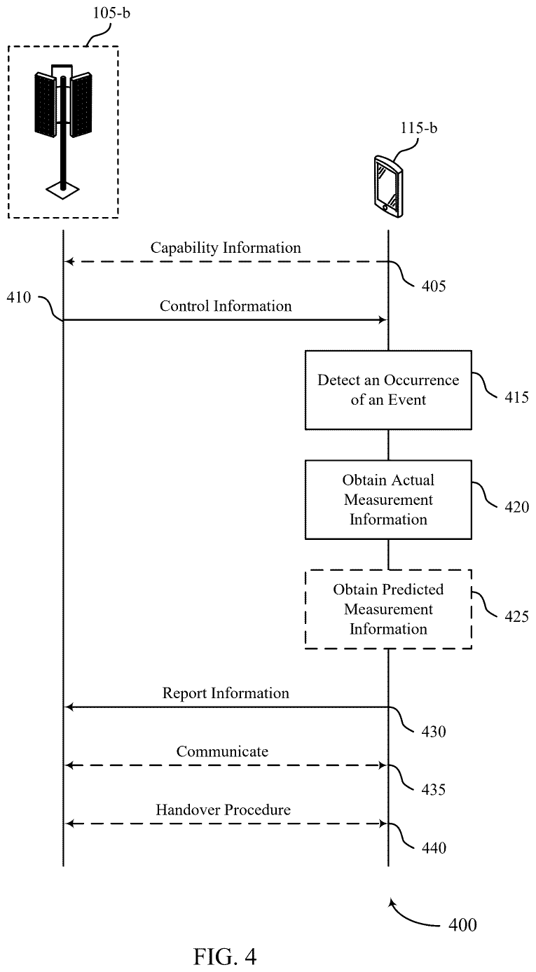

FIG. 4 shows an example of a process flow 400 that supports enhanced event-triggered measurement reports in accordance with one or more aspects of the present disclosure. In some examples, process flow 400 may implement aspects of wireless communication system 100, wireless communication system 200, first measurement timeline 300, or second measurement timeline 301. For example, the process flow 400 may include a UE 115-b and a network entity 105-b which may be examples of corresponding devices described with reference to FIGS. 1-3.

At 405, the UE 115-b may transmit capability information that indicates a measurement capability of the UE 115-b.

In some cases, at 410, the network entity 105-b may transmit control information that includes actual measurement control information for obtainment of the actual measurement information, predicted measurement control information for obtainment of the predicted measurement information, and an order of the rate of change information, wherein the order is a derivative order At least one of: the actual measurement control information, the predicted measurement control information, or the order of the rate of change information may be based on the capability information.

In some cases, at 410, the network entity 105-b may transmit control information that indicates at least one of: a first scaling factor associated with the actual measurement information or a second scaling factor associated with the predicted measurement information. The rate of change information may be based on at least one of: the first scaling factor or the second scaling factor.

The actual measurement control information may include at least one of: information indicative of a quantity of actual measurements or information indicative of the first duration associated with the actual measurement information. The predicted measurement control information may include at least one of: information indicative of a quantity of predicted measurements or information indicative of the second duration associated with the predicted measurement information.

At 415, the UE 115-b may detect an occurrence of an event associated with a serving beam of a serving cell or a candidate beam of a candidate cell.

At 420, the UE 115-b may obtain, based on the occurrence of the event at operation 415, actual measurement information indicative of at least one of: the serving beam during a first duration or the candidate beam during the first duration. In some cases, to obtain the actual measurement information, the UE 115-a may perform one or more actual measurements via one or more measurement resources. In some cases, to obtain the actual measurement information, the UE 115-a may perform one or more actual measurements via one or more data resources.

At 425, the UE 115-b may obtain the predicted measurement information based on the actual measurement information. The rate of change information may be based on the predicted measurement information.

At 430, the UE 115-b may transmit report information based on the occurrence of the event at operation 415. The report information may include at least one of: rate of change information associated with the actual measurement information or predicted measurement information. The predicted measurement information may be indicative of at least one of: the serving beam during a second duration or the candidate beam during the second duration. The second duration may be after the first duration.

In some cases, the report information comprises at least one of: an identifier associated with the serving beam or the candidate beam, a predicted timing associated with the predicted measurement information, or a confidence level associated with the predicted measurement information. the rate of change information includes: a derivative value associated with the actual measurement information or the predicted measurement information, and an order of a derivative associated with the derivative value.

In some cases, the report information may include the actual measurement information, the predicted measurement information, and the rate of change information associated with the serving beam or the candidate beam based on the rate of change information being indicative of a positive rate of change over the second duration. In some cases, the report information may exclude second actual measurement information, second predicted measurement information, and second rate of change information associated with a second candidate beam based on the second rate of change information being indicative of a negative rate of change over the second duration.

In some cases, at 435, the UE 115-b may communicate with the second network entity via the candidate beam based on the rate of change information. The mobility information may indicate the candidate beam as an active beam. In some cases, at 440, the UE 115-b may perform a handover procedure for the second network entity based on the rate of change information. The mobility information indicates the handover procedure.

The UE 115-b may obtain, during the second duration, additional actual measurement information indicative of at least on of: the serving beam during the first duration or the candidate beam during the first duration.

The UE 115-b may update at least one of: actual measurement control information for obtainment of second actual measurement information, predicted measurement control information for obtainment of second predicted measurement information, or an order of the rate of change information based on a difference between the additional actual measurement information and the predicted measurement information.

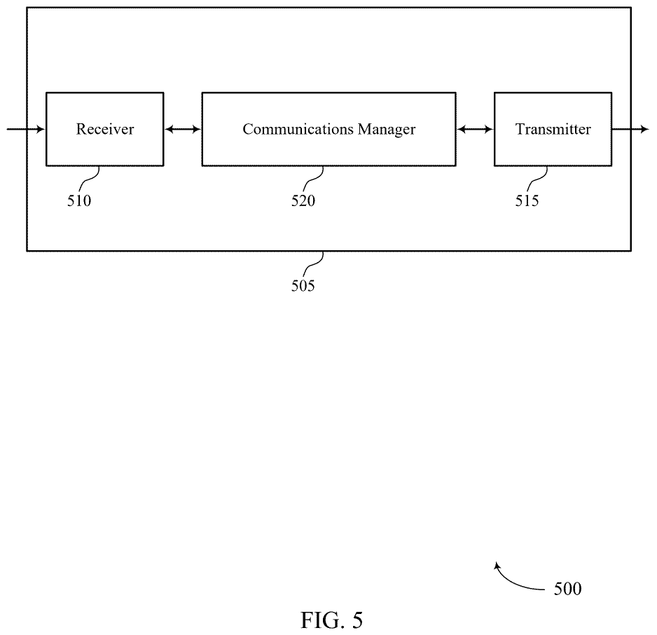

FIG. 5 shows a block diagram 500 of a device 505 that supports enhanced event-triggered measurement reports in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to enhanced event-triggered measurement reports). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enhanced event-triggered measurement reports). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of enhanced event-triggered measurement reports as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

Additionally, or alternatively, the communications manager 520 may support wireless communication in accordance with examples as disclosed herein. For example, the communications manager 520 is capable of, configured to, or operable to support a means for detecting an occurrence of an event associated with a serving beam of a serving cell or a candidate beam of a candidate cell. The communications manager 520 is capable of, configured to, or operable to support a means for obtaining, based on the occurrence of the event, actual measurement information indicative of at least one of: the serving beam during a first duration or the candidate beam during the first duration. The communications manager 520 is capable of, configured to, or operable to support a means for transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources and the like.

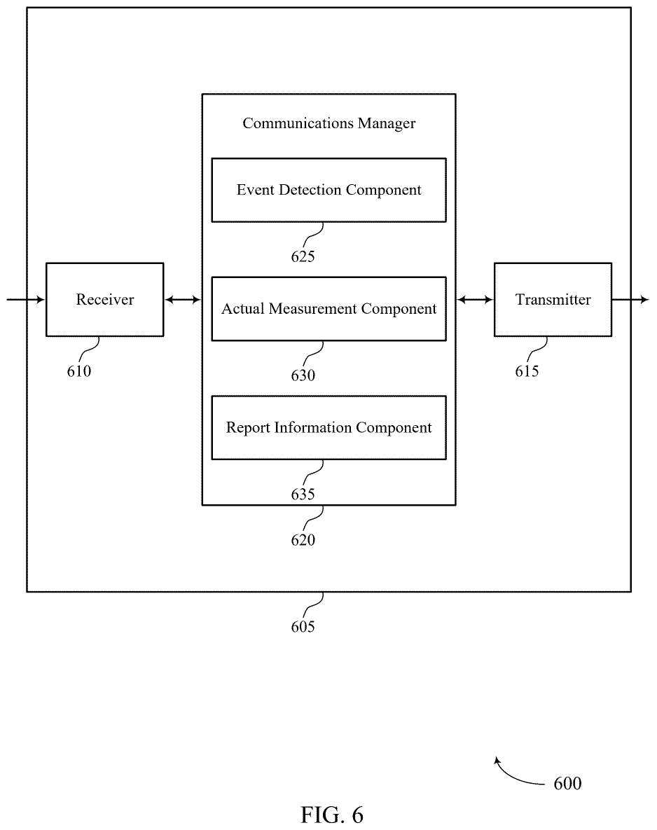

FIG. 6 shows a block diagram 600 of a device 605 that supports enhanced event-triggered measurement reports in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to enhanced event-triggered measurement reports). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enhanced event-triggered measurement reports). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of enhanced event-triggered measurement reports as described herein. For example, the communications manager 620 may include an event detection component 625, an actual measurement component 630, a report information component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The event detection component 625 is capable of, configured to, or operable to support a means for detecting an occurrence of an event associated with a serving beam of a serving cell or a candidate beam of a candidate cell. The actual measurement component 630 is capable of, configured to, or operable to support a means for obtaining, based on the occurrence of the event, actual measurement information indicative of at least one of: the serving beam during a first duration or the candidate beam during the first duration. The report information component 635 is capable of, configured to, or operable to support a means for transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration.

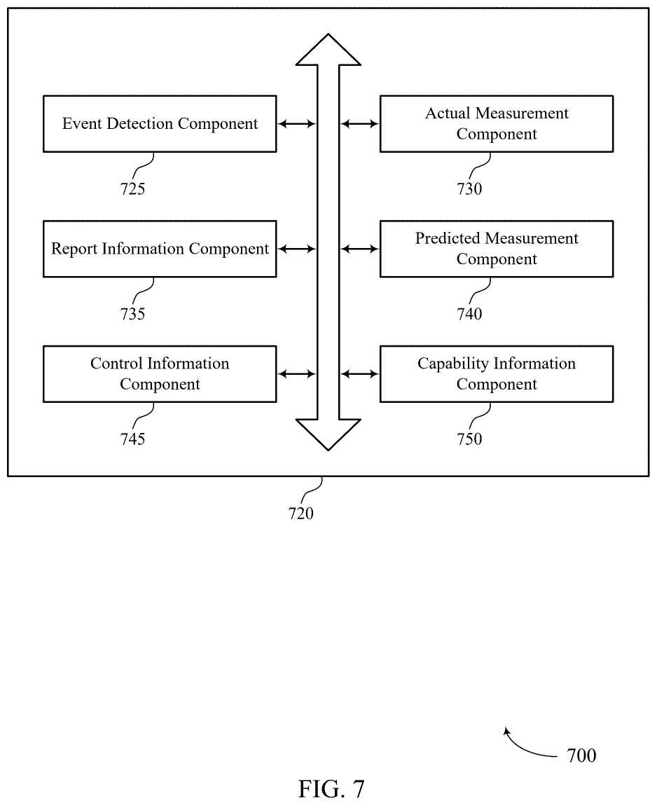

FIG. 7 shows a block diagram 700 of a communications manager 720 that supports enhanced event-triggered measurement reports in accordance with one or more aspects of the present disclosure. The communications manager 720 may be an example of aspects of a communications manager 520, a communications manager 620, or both, as described herein. The communications manager 720, or various components thereof, may be an example of means for performing various aspects of enhanced event-triggered measurement reports as described herein. For example, the communications manager 720 may include an event detection component 725, an actual measurement component 730, a report information component 735, a predicted measurement component 740, a control information component 745, a capability information component 750, or any combination thereof. Each of these components, or components or subcomponents thereof (e.g., one or more processors, one or more memories), may communicate, directly or indirectly, with one another (e.g., via one or more buses).

Additionally, or alternatively, the communications manager 720 may support wireless communication in accordance with examples as disclosed herein. The event detection component 725 is capable of, configured to, or operable to support a means for detecting an occurrence of an event associated with a serving beam of a serving cell or a candidate beam of a candidate cell. The actual measurement component 730 is capable of, configured to, or operable to support a means for obtaining, based on the occurrence of the event, actual measurement information indicative of at least one of: the serving beam during a first duration or the candidate beam during the first duration. The report information component 735 is capable of, configured to, or operable to support a means for transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration.

In some examples, the predicted measurement component 740 is capable of, configured to, or operable to support a means for obtaining the predicted measurement information based on the actual measurement information, where the rate of change information is based on the predicted measurement information.

In some examples, the control information component 745 is capable of, configured to, or operable to support a means for receiving control information that includes actual measurement control information for obtainment of the actual measurement information, predicted measurement control information for obtainment of the predicted measurement information, and an order of the rate of change information, where the order is a derivative order.

In some examples, the capability information component 750 is capable of, configured to, or operable to support a means for transmitting capability information that indicates a measurement capability of the network entity, where at least one of: the actual measurement control information, the predicted measurement control information, or the order of the rate of change information is based on the capability information.

In some examples, information indicative of a quantity of actual measurements or information indicative of the first duration associated with the actual measurement information, and where the predicted measurement control information includes at least one of. In some examples, information indicative of a quantity of predicted measurements or information indicative of the second duration associated with the predicted measurement information.

In some examples, the actual measurement component 730 is capable of, configured to, or operable to support a means for obtaining, during the second duration, additional actual measurement information indicative of at least on of: the serving beam during the first duration or the candidate beam during the first duration. In some examples, the control information component 745 is capable of, configured to, or operable to support a means for updating at least one of: actual measurement control information for obtainment of second actual measurement information, predicted measurement control information for obtainment of second predicted measurement information, or an order of the rate of change information based on a difference between the additional actual measurement information and the predicted measurement information.

In some examples, the control information component 745 is capable of, configured to, or operable to support a means for receiving control information that indicates at least one of: a first scaling factor associated with the actual measurement information or a second scaling factor associated with the predicted measurement information, where the rate of change information is based on at least one of: the first scaling factor or the second scaling factor.

In some examples, to support obtaining the actual measurement information, the actual measurement component 730 is capable of, configured to, or operable to support a means for performing one or more actual measurements via one or more measurement resources.

In some examples, to support obtaining the actual measurement information, the actual measurement component 730 is capable of, configured to, or operable to support a means for performing one or more actual measurements via one or more data resources.

In some examples, the report information includes at least one of: an identifier associated with the serving beam or the candidate beam, a predicted timing associated with the predicted measurement information, or a confidence level associated with the predicted measurement information.

In some examples, the rate of change information includes a derivative value associated with the actual measurement information or the predicted measurement information, and an order of a derivative associated with the derivative value.

In some examples, the report information includes the actual measurement information, the predicted measurement information, and the rate of change information associated with the serving beam or the candidate beam based on the rate of change information being indicative of a positive rate of change over the second duration.

In some examples, the report information excludes second actual measurement information, second predicted measurement information, and second rate of change information associated with a second candidate beam based on the second rate of change information being indicative of a negative rate of change over the second duration.

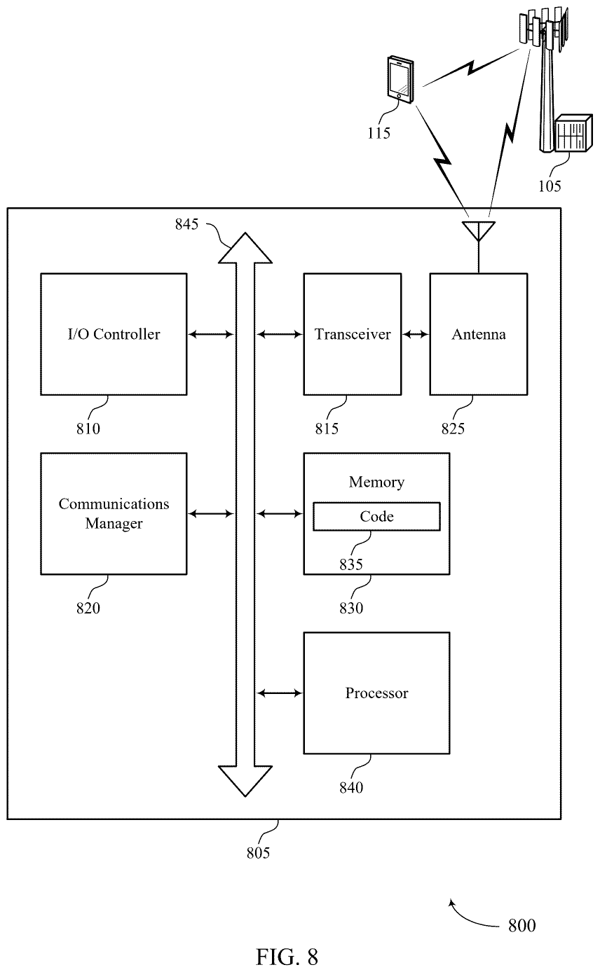

FIG. 8 shows a diagram of a system 800 including a device 805 that supports enhanced event-triggered measurement reports in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting enhanced event-triggered measurement reports). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

Additionally, or alternatively, the communications manager 820 may support wireless communication in accordance with examples as disclosed herein. For example, the communications manager 820 is capable of, configured to, or operable to support a means for detecting an occurrence of an event associated with a serving beam of a serving cell or a candidate beam of a candidate cell. The communications manager 820 is capable of, configured to, or operable to support a means for obtaining, based on the occurrence of the event, actual measurement information indicative of at least one of: the serving beam during a first duration or the candidate beam during the first duration. The communications manager 820 is capable of, configured to, or operable to support a means for transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration.

By including or configuring the communications manager 820 in accordance with examples as described herein, the device 805 may support techniques for improved communication reliability, reduced latency, more efficient utilization of communication resources, improved coordination between devices, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of enhanced event-triggered measurement reports as described herein, or the at least one processor 840 and the at least one memory 830 may be otherwise configured to, individually or collectively, perform or support such operations.

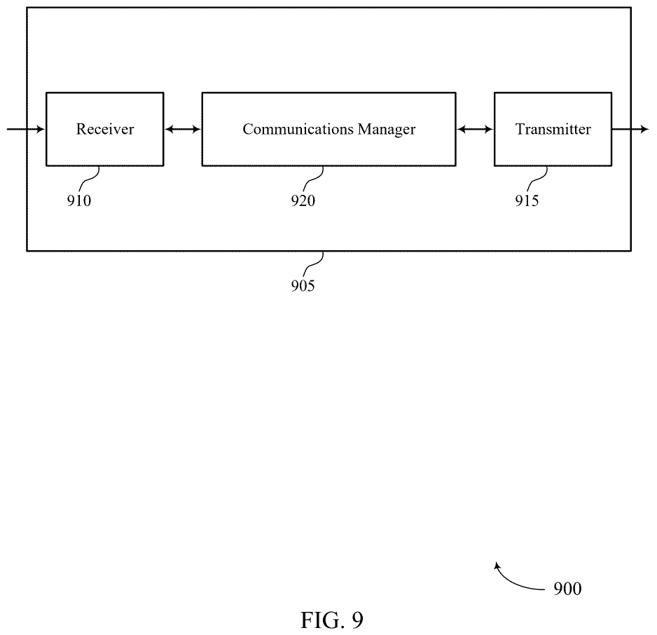

FIG. 9 shows a block diagram 900 of a device 905 that supports enhanced event-triggered measurement reports in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of enhanced event-triggered measurement reports as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

Additionally, or alternatively, the communications manager 920 may support wireless communication in accordance with examples as disclosed herein. For example, the communications manager 920 is capable of, configured to, or operable to support a means for receiving report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration. The communications manager 920 is capable of, configured to, or operable to support a means for transmitting mobility information to the second network entity, where the mobility information is based on the rate of change information.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources and the like.

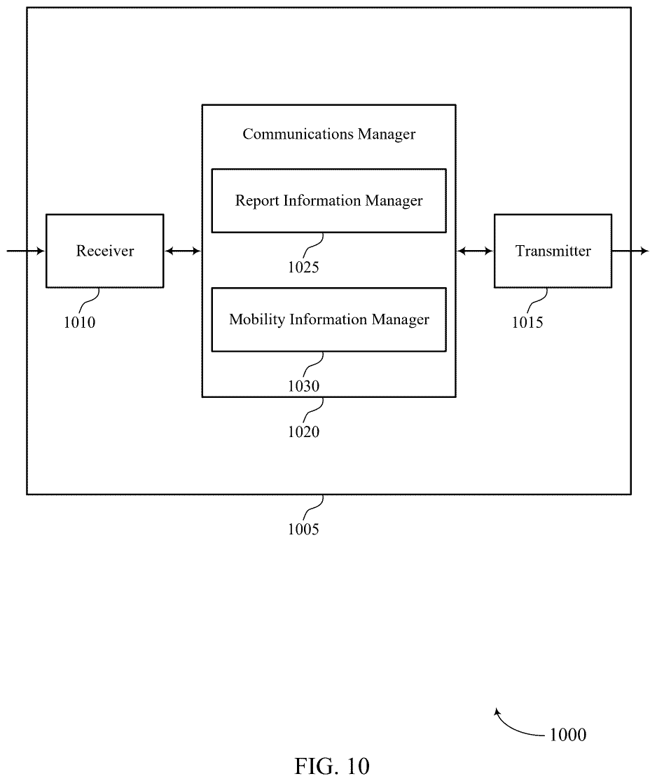

FIG. 10 shows a block diagram 1000 of a device 1005 that supports enhanced event-triggered measurement reports in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of enhanced event-triggered measurement reports as described herein. For example, the communications manager 1020 may include a report information manager 1025 a mobility information manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The report information manager 1025 is capable of, configured to, or operable to support a means for receiving report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration. The mobility information manager 1030 is capable of, configured to, or operable to support a means for transmitting mobility information to the second network entity, where the mobility information is based on the rate of change information.

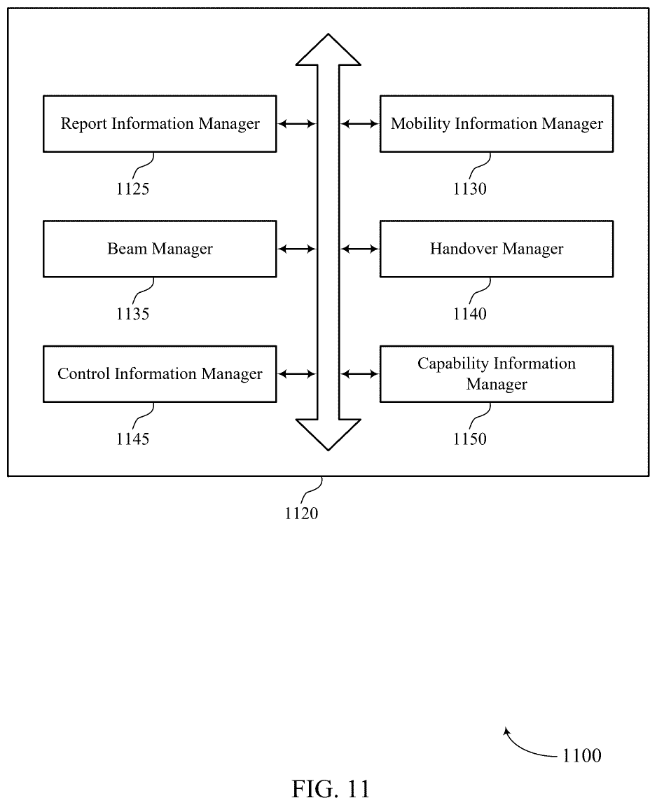

FIG. 11 shows a block diagram 1100 of a communications manager 1120 that supports enhanced event-triggered measurement reports in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of enhanced event-triggered measurement reports as described herein. For example, the communications manager 1120 may include a report information manager 1125, a mobility information manager 1130, a beam manager 1135, a handover manager 1140, a control information manager 1145, a capability information manager 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1120 may support wireless communication in accordance with examples as disclosed herein. The report information manager 1125 is capable of, configured to, or operable to support a means for receiving report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration. The mobility information manager 1130 is capable of, configured to, or operable to support a means for transmitting mobility information to the second network entity, where the mobility information is based on the rate of change information.

In some examples, the beam manager 1135 is capable of, configured to, or operable to support a means for communicating with the second network entity via the candidate beam based on the rate of change information, where the mobility information indicates the candidate beam as an active beam.

In some examples, the handover manager 1140 is capable of, configured to, or operable to support a means for performing a handover procedure for the second network entity based on the rate of change information, where the mobility information indicates the handover procedure.

In some examples, the control information manager 1145 is capable of, configured to, or operable to support a means for transmitting control information that includes actual measurement control information for obtainment of the actual measurement information, predicted measurement control information for obtainment of the predicted measurement information, and an order of the rate of change information, where the order is a derivative order.

In some examples, the capability information manager 1150 is capable of, configured to, or operable to support a means for receiving capability information that indicates a measurement capability of the second network entity, where at least one of: the actual measurement control information, the predicted measurement control information, or the order of the rate of change information is based on the capability information.

In some examples, information indicative of a quantity of the actual measurement information or information indicative of the first duration associated with the actual measurement information, and where the predicted measurement control information includes at least one of. In some examples, information indicative of a quantity of the predicted measurement information or information indicative of the second duration associated with the predicted measurement information.

In some examples, the control information manager 1145 is capable of, configured to, or operable to support a means for transmitting control information that indicates at least one of: a first scaling factor associated with the actual measurement information, a second scaling factor associated with the predicted measurement information, where the rate of change information is based on at least one of: the first scaling factor or the second scaling factor.

In some examples, the report information includes at least one of: an identifier associated with the serving beam or the candidate beam, a predicted timing associated with the predicted measurement information, or a confidence level associated with the predicted measurement information.

In some examples, the rate of change information includes: a derivative value associated with the actual measurement information or the predicted measurement information, and an order of a derivative associated with the derivative value.

In some examples, the report information includes the actual measurement information, the predicted measurement information, and the rate of change information associated with the serving beam or the candidate beam based on the rate of change information being indicative of a positive rate of change over the second duration.

In some examples, the report information excludes second actual measurement information, second predicted measurement information, and second rate of change information associated with a second candidate beam based on the second rate of change information being indicative of a negative rate of change over the second duration.

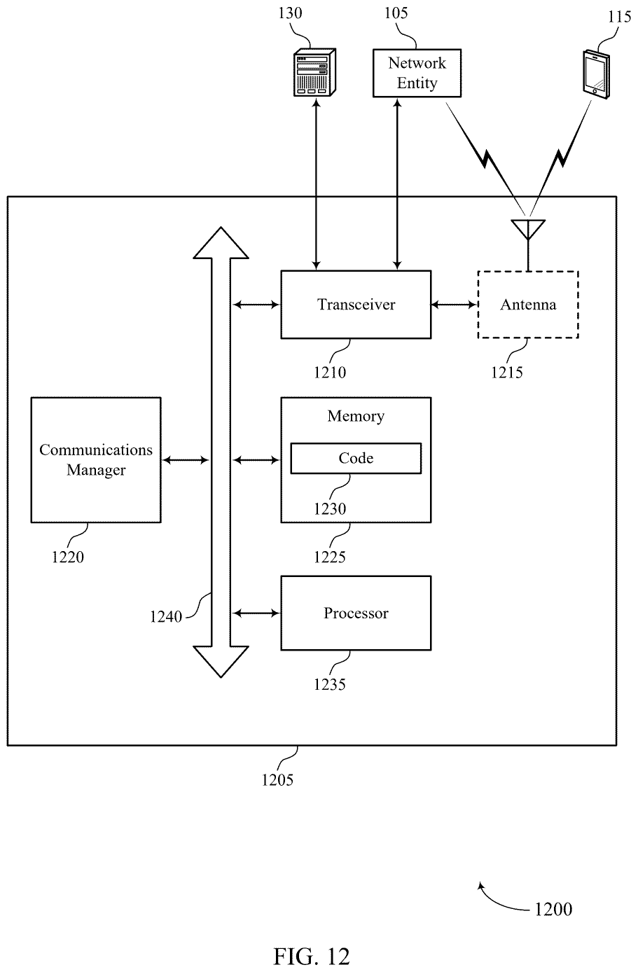

FIG. 12 shows a diagram of a system 1200 including a device 1205 that supports enhanced event-triggered measurement reports in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting enhanced event-triggered measurement reports). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communication network technology to provide communication between network entities 105.

Additionally, or alternatively, the communications manager 1220 may support wireless communication in accordance with examples as disclosed herein. For example, the communications manager 1220 is capable of, configured to, or operable to support a means for receiving report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration. The communications manager 1220 is capable of, configured to, or operable to support a means for transmitting mobility information to the second network entity, where the mobility information is based on the rate of change information.

By including or configuring the communications manager 1220 in accordance with examples as described herein, the device 1205 may support techniques for improved communication reliability, reduced latency, more efficient utilization of communication resources, improved coordination between devices, and the like.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of enhanced event-triggered measurement reports as described herein, or the at least one processor 1235 and the at least one memory 1225 may be otherwise configured to, individually or collectively, perform or support such operations.

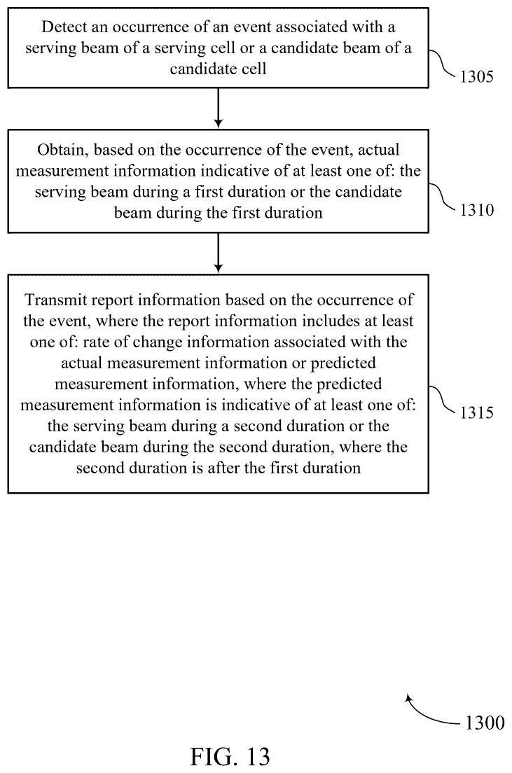

FIG. 13 shows a flowchart illustrating a method 1300 that supports enhanced event-triggered measurement reports in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include detecting an occurrence of an event associated with a serving beam of a serving cell or a candidate beam of a candidate cell. The operations of 1305 may be performed in accordance with examples as disclosed herein. In some examples, aspects of the operations of 1305 may be performed by an event detection component 725 as described with reference to FIG. 7.

At 1310, the method may include obtaining, based on the occurrence of the event, actual measurement information indicative of at least one of: the serving beam during a first duration or the candidate beam during the first duration. The operations of 1310 may be performed in accordance with examples as disclosed herein. In some examples, aspects of the operations of 1310 may be performed by an actual measurement component 730 as described with reference to FIG. 7.

At 1315, the method may include transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration. The operations of 1315 may be performed in accordance with examples as disclosed herein. In some examples, aspects of the operations of 1315 may be performed by a report information component 735 as described with reference to FIG. 7.

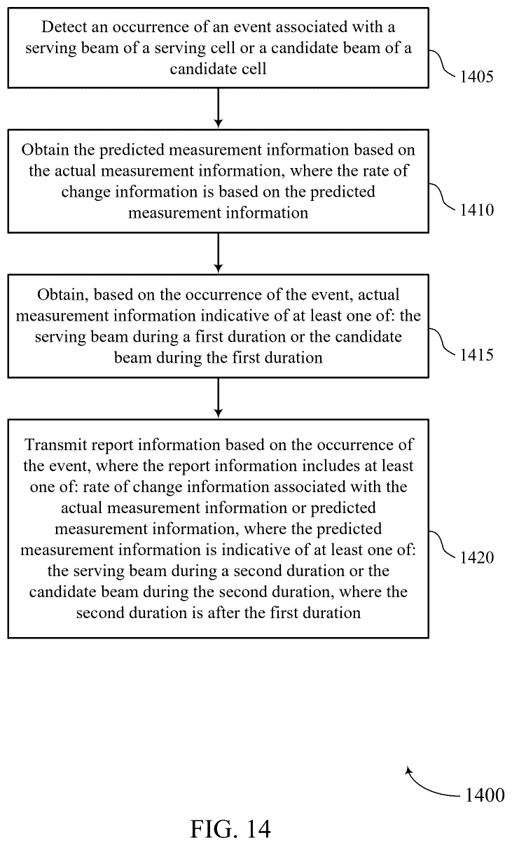

FIG. 14 shows a flowchart illustrating a method 1400 that supports enhanced event-triggered measurement reports in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include detecting an occurrence of an event associated with a serving beam of a serving cell or a candidate beam of a candidate cell. The operations of 1405 may be performed in accordance with examples as disclosed herein. In some examples, aspects of the operations of 1405 may be performed by an event detection component 725 as described with reference to FIG. 7.

At 1410, the method may include obtaining the predicted measurement information based on the actual measurement information, where the rate of change information is based on the predicted measurement information. The operations of 1410 may be performed in accordance with examples as disclosed herein. In some examples, aspects of the operations of 1410 may be performed by a predicted measurement component 740 as described with reference to FIG. 7.

At 1415, the method may include obtaining, based on the occurrence of the event, actual measurement information indicative of at least one of: the serving beam during a first duration or the candidate beam during the first duration. The operations of 1415 may be performed in accordance with examples as disclosed herein. In some examples, aspects of the operations of 1415 may be performed by an actual measurement component 730 as described with reference to FIG. 7.

At 1420, the method may include transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration. The operations of 1420 may be performed in accordance with examples as disclosed herein. In some examples, aspects of the operations of 1420 may be performed by a report information component 735 as described with reference to FIG. 7.

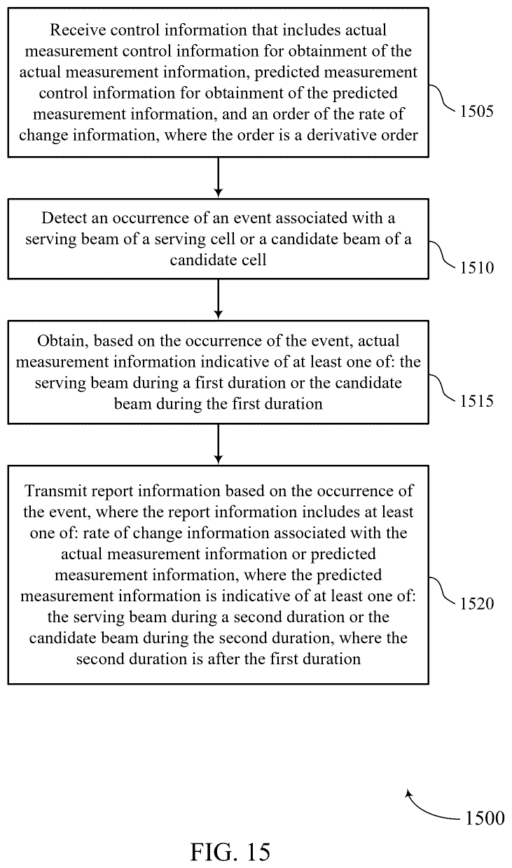

FIG. 15 shows a flowchart illustrating a method 1500 that supports enhanced event-triggered measurement reports in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving control information that includes actual measurement control information for obtainment of the actual measurement information, predicted measurement control information for obtainment of the predicted measurement information, and an order of the rate of change information, where the order is a derivative order. The operations of 1505 may be performed in accordance with examples as disclosed herein. In some examples, aspects of the operations of 1505 may be performed by a control information component 745 as described with reference to FIG. 7.

At 1510, the method may include detecting an occurrence of an event associated with a serving beam of a serving cell or a candidate beam of a candidate cell. The operations of 1510 may be performed in accordance with examples as disclosed herein. In some examples, aspects of the operations of 1510 may be performed by an event detection component 725 as described with reference to FIG. 7.

At 1515, the method may include obtaining, based on the occurrence of the event, actual measurement information indicative of at least one of: the serving beam during a first duration or the candidate beam during the first duration. The operations of 1515 may be performed in accordance with examples as disclosed herein. In some examples, aspects of the operations of 1515 may be performed by an actual measurement component 730 as described with reference to FIG. 7.

At 1520, the method may include transmitting report information based on the occurrence of the event, where the report information includes at least one of: rate of change information associated with the actual measurement information or predicted measurement information, where the predicted measurement information is indicative of at least one of: the serving beam during a second duration or the candidate beam during the second duration, where the second duration is after the first duration. The operations of 1520 may be performed in accordance with examples as disclosed herein. In some examples, aspects of the operations of 1520 may be performed by a report information component 735 as described with reference to FIG. 7.

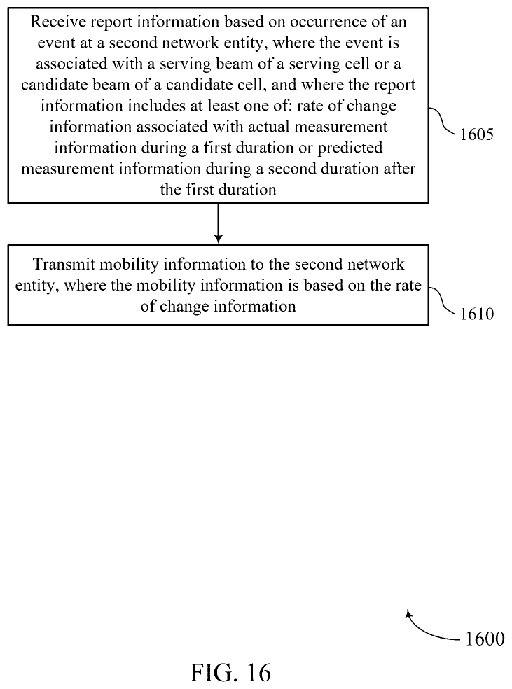

FIG. 16 shows a flowchart illustrating a method 1600 that supports enhanced event-triggered measurement reports in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration. The operations of 1605 may be performed in accordance with examples as disclosed herein. In some examples, aspects of the operations of 1605 may be performed by a report information manager 1125 as described with reference to FIG. 11.

At 1610, the method may include transmitting mobility information to the second network entity, where the mobility information is based on the rate of change information. The operations of 1610 may be performed in accordance with examples as disclosed herein. In some examples, aspects of the operations of 1610 may be performed by a mobility information manager 1130 as described with reference to FIG. 11.

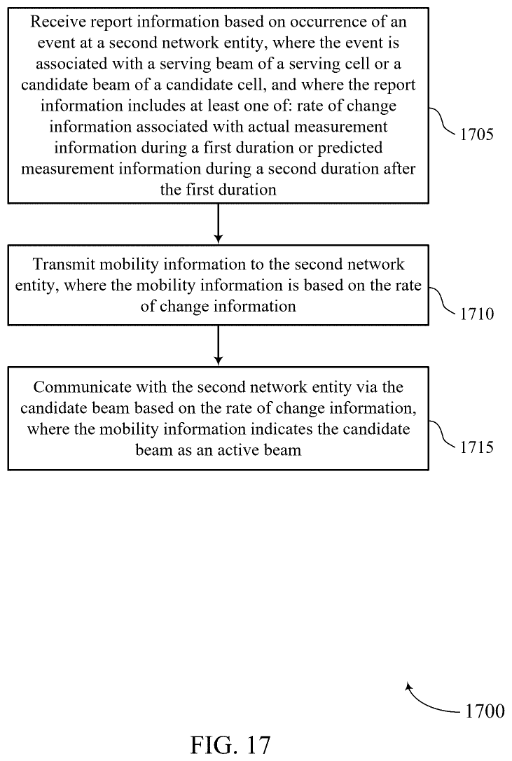

FIG. 17 shows a flowchart illustrating a method 1700 that supports enhanced event-triggered measurement reports in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include receiving report information based on occurrence of an event at a second network entity, where the event is associated with a serving beam of a serving cell or a candidate beam of a candidate cell, and where the report information includes at least one of: rate of change information associated with actual measurement information during a first duration or predicted measurement information during a second duration after the first duration. The operations of 1705 may be performed in accordance with examples as disclosed herein. In some examples, aspects of the operations of 1705 may be performed by a report information manager 1125 as described with reference to FIG. 11.

At 1710, the method may include transmitting mobility information to the second network entity, where the mobility information is based on the rate of change information. The operations of 1710 may be performed in accordance with examples as disclosed herein. In some examples, aspects of the operations of 1710 may be performed by a mobility information manager 1130 as described with reference to FIG. 11.

At 1715, the method may include communicating with the second network entity via the candidate beam based on the rate of change information, where the mobility information indicates the candidate beam as an active beam. The operations of 1715 may be performed in accordance with examples as disclosed herein. In some examples, aspects of the operations of 1715 may be performed by a beam manager 1135 as described with reference to FIG. 11.

The following provides an overview of aspects of the present disclosure:
Aspect 1: A method for wireless communication by a network entity, comprising: detecting an occurrence of an event associated with a serving beam of a serving cell or a candidate beam of a candidate cell; obtaining, based on the occurrence of the event, actual measurement information indicative of at least one of: the serving beam during a first duration or the candidate beam during the first duration; and transmitting report information based on the occurrence of the event, wherein the report information includes at least one of: rate of change information associated with the actual measurement information or predicted measurement information, wherein the predicted measurement information is indicative of at least one of: the serving beam during a second duration or the candidate beam during the second duration, wherein the second duration is after the first duration.
Aspect 2: The method of aspect 1, further comprising: obtaining the predicted measurement information based on the actual measurement information, wherein the rate of change information is based on the predicted measurement information.
Aspect 3: The method of any of aspects 1 through 2, further comprising: receiving control information that includes actual measurement control information for obtainment of the actual measurement information, predicted measurement control information for obtainment of the predicted measurement information, and an order of the rate of change information, wherein the order is a derivative order.
Aspect 4: The method of aspect 3, further comprising: transmitting capability information that indicates a measurement capability of the network entity, wherein at least one of: the actual measurement control information, the predicted measurement control information, or the order of the rate of change information is based on the capability information.
Aspect 5: The method of any of aspects 3 through 4, wherein the actual measurement control information includes at least one of information indicative of a quantity of actual measurements or information indicative of the first duration associated with the actual measurement information, and wherein the predicted measurement control information includes at least one of information indicative of a quantity of predicted measurements or information indicative of the second duration associated with the predicted measurement information.
Aspect 6: The method of any of aspects 1 through 5, further comprising: obtaining, during the second duration, additional actual measurement information indicative of at least on of: the serving beam during the first duration or the candidate beam during the first duration; and updating at least one of: actual measurement control information for obtainment of second actual measurement information, predicted measurement control information for obtainment of second predicted measurement information, or an order of the rate of change information based on a difference between the additional actual measurement information and the predicted measurement information.
Aspect 7: The method of any of aspects 1 through 6, further comprising: receiving control information that indicates at least one of: a first scaling factor associated with the actual measurement information or a second scaling factor associated with the predicted measurement information, wherein the rate of change information is based on at least one of: the first scaling factor or the second scaling factor.
Aspect 8: The method of any of aspects 1 through 7, wherein obtaining the actual measurement information comprises: performing one or more actual measurements via one or more measurement resources.
Aspect 9: The method of any of aspects 1 through 8, wherein obtaining the actual measurement information comprises: performing one or more actual measurements via one or more data resources.
Aspect 10: The method of any of aspects 1 through 9, wherein the report information comprises at least one of: an identifier associated with the serving beam or the candidate beam, a predicted timing associated with the predicted measurement information, or a confidence level associated with the predicted measurement information.
Aspect 11: The method of any of aspects 1 through 10, wherein the rate of change information comprises: a derivative value associated with the actual measurement information or the predicted measurement information, and an order of a derivative associated with the derivative value.
Aspect 12: The method of any of aspects 1 through 11, wherein the report information comprises the actual measurement information, the predicted measurement information, and the rate of change information associated with the serving beam or the candidate beam based on the rate of change information being indicative of a positive rate of change over the second duration.
Aspect 13: The method of any of aspects 1 through 12, wherein the report information excludes second actual measurement information, second predicted measurement information, and second rate of change information associated with a second candidate beam based on the second rate of change information being indicative of a negative rate of change over the second duration.
Aspect 14: A method for wireless communication by a first network entity for wireless communication, comprising: receiving report information based on occurrence of an event at a second network entity, wherein the event is associated with a serving beam of a serving cell or a candidate beam of a candidate cell, and wherein the report information includes at least one of: rate of change information associated with actual measurement information during a first duration or predicted measurement information during a second duration after the first duration; and transmitting mobility information to the second network entity, wherein the mobility information is based on the rate of change information.
Aspect 15: The method of aspect 14, further comprising: communicating with the second network entity via the candidate beam based on the rate of change information, wherein the mobility information indicates the candidate beam as an active beam.
Aspect 16: The method of any of aspects 14 through 15, further comprising: performing a handover procedure for the second network entity based on the rate of change information, wherein the mobility information indicates the handover procedure.
Aspect 17: The method of any of aspects 14 through 16, further comprising: transmitting control information that includes actual measurement control information for obtainment of the actual measurement information, predicted measurement control information for obtainment of the predicted measurement information, and an order of the rate of change information, wherein the order is a derivative order.
Aspect 18: The method of aspect 17, further comprising: receiving capability information that indicates a measurement capability of the second network entity, wherein at least one of: the actual measurement control information, the predicted measurement control information, or the order of the rate of change information is based on the capability information.
Aspect 19: The method of any of aspects 17 through 18, wherein the actual measurement control information includes at least one of information indicative of a quantity of actual measurements or information indicative of the first duration associated with the actual measurement information, and wherein the predicted measurement control information includes at least one of information indicative of a quantity of predicted measurements or information indicative of the second duration associated with the predicted measurement information.
Aspect 20: The method of any of aspects 14 through 19, further comprising: transmitting control information that indicates at least one of: a first scaling factor associated with the actual measurement information, a second scaling factor associated with the predicted measurement information, wherein the rate of change information is based on at least one of: the first scaling factor or the second scaling factor.
Aspect 21: The method of any of aspects 14 through 20, wherein the report information comprises at least one of: an identifier associated with the serving beam or the candidate beam, a predicted timing associated with the predicted measurement information, or a confidence level associated with the predicted measurement information.
Aspect 22: The method of any of aspects 14 through 21, wherein the rate of change information comprises: a derivative value associated with the actual measurement information or the predicted measurement information, and an order of a derivative associated with the derivative value.
Aspect 23: The method of any of aspects 14 through 22, wherein the report information comprises the actual measurement information, the predicted measurement information, and the rate of change information associated with the serving beam or the candidate beam based on the rate of change information being indicative of a positive rate of change over the second duration.
Aspect 24: The method of any of aspects 14 through 23, wherein the report information excludes second actual measurement information, second predicted measurement information, and second rate of change information associated with a second candidate beam based on the second rate of change information being indicative of a negative rate of change over the second duration.
Aspect 25: A network entity for wireless communication, comprising one or more memories storing processor-executable code, and one or more processors coupled with the one or more memories and individually or collectively operable to execute the code to cause the network entity to perform a method of any of aspects 1 through 13.
Aspect 26: A network entity for wireless communication, comprising at least one means for performing a method of any of aspects 1 through 13.
Aspect 27: A non-transitory computer-readable medium storing code for wireless communication, the code comprising instructions executable by one or more processors to perform a method of any of aspects 1 through 13.
Aspect 28: A first network entity for wireless communication for wireless communication, comprising one or more memories storing processor-executable code, and one or more processors coupled with the one or more memories and individually or collectively operable to execute the code to cause the first network entity for wireless communication to perform a method of any of aspects 14 through 24.
Aspect 29: A first network entity for wireless communication for wireless communication, comprising at least one means for performing a method of any of aspects 14 through 24.
Aspect 30: A non-transitory computer-readable medium storing code for wireless communication, the code comprising instructions executable by one or more processors to perform a method of any of aspects 14 through 24.

The methods described herein describe possible implementations, and the operations and the steps may be rearranged or otherwise modified. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified nouns in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set of one or more items).

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
detect an occurrence of an event associated with a serving beam of a serving cell or a candidate beam of a candidate cell;
obtain, based on the occurrence of the event, actual measurement information indicative of at least one of: the serving beam during a first duration or the candidate beam during the first duration; and
transmit report information based on the occurrence of the event, wherein the report information includes at least one of: rate of change information associated with the actual measurement information or predicted measurement information, wherein the predicted measurement information is indicative of at least one of: the serving beam during a second duration or the candidate beam during the second duration, wherein the second duration is after the first duration.

2. The network entity of claim 1, wherein the processing system is configured to obtain the predicted measurement information based on the actual measurement information, wherein the rate of change information is based on the predicted measurement information.

3. The network entity of claim 1, wherein the processing system is configured to receive control information that includes actual measurement control information for obtainment of the actual measurement information, predicted measurement control information for obtainment of the predicted measurement information, and an order of the rate of change information, wherein the order is a derivative order.

4. The network entity of claim 3, wherein the processing system is configured to transmit capability information that indicates a measurement capability of the network entity, wherein at least one of: the actual measurement control information, the predicted measurement control information, or the order of the rate of change information is based on the capability information.

5. The network entity of claim 3, wherein the actual measurement control information includes at least one of information indicative of a quantity of actual measurements or information indicative of the first duration associated with the actual measurement information, and wherein the predicted measurement control information includes at least one of: information indicative of a quantity of predicted measurements or information indicative of the second duration associated with the predicted measurement information.

6. The network entity of claim 1, wherein the processing system is configured to:
obtain, during the second duration, additional actual measurement information indicative of at least on of: the serving beam during the first duration or the candidate beam during the first duration; and
update at least one of:
actual measurement control information for obtainment of second actual measurement information,
predicted measurement control information for obtainment of second predicted measurement information, or
an order of the rate of change information based on a difference between the additional actual measurement information and the predicted measurement information.

7. The network entity of claim 1, wherein the processing system is configured to receive control information that indicates at least one of: a first scaling factor associated with the actual measurement information or a second scaling factor associated with the predicted measurement information, wherein the rate of change information is based on at least one of: the first scaling factor or the second scaling factor.

8. The network entity of claim 1, wherein to obtain the actual measurement information, the processing system is configured to perform one or more actual measurements via one or more measurement resources.

9. The network entity of claim 1, wherein to obtain the actual measurement information, the processing system is configured to perform one or more actual measurements via one or more data resources.

10. The network entity of claim 1, wherein the report information comprises at least one of:
an identifier associated with the serving beam or the candidate beam,
a predicted timing associated with the predicted measurement information, or
a confidence level associated with the predicted measurement information.

11. The network entity of claim 1, wherein the rate of change information comprises:
a derivative value associated with the actual measurement information or the predicted measurement information, and
an order of a derivative associated with the derivative value.

12. The network entity of claim 1, wherein the report information comprises the actual measurement information, the predicted measurement information, and the rate of change information associated with the serving beam or the candidate beam based on the rate of change information being indicative of a positive rate of change over the second duration.

13. The network entity of claim 1, wherein the report information excludes second actual measurement information, second predicted measurement information, and second rate of change information associated with a second candidate beam based on the second rate of change information being indicative of a negative rate of change over the second duration.

14. A method for wireless communication by a network entity, comprising:
detecting an occurrence of an event associated with a serving beam of a serving cell or a candidate beam of a candidate cell;
obtaining, based on the occurrence of the event, actual measurement information indicative of at least one of: the serving beam during a first duration or the candidate beam during the first duration; and
transmitting report information based on the occurrence of the event, wherein the report information includes at least one of: rate of change information associated with the actual measurement information or predicted measurement information, wherein the predicted measurement information is indicative of at least one of: the serving beam during a second duration or the candidate beam during the second duration, wherein the second duration is after the first duration.

15. The method of claim 14, further comprising:
obtaining the predicted measurement information based on the actual measurement information, wherein the rate of change information is based on the predicted measurement information.

16. The method of claim 14, further comprising:
receiving control information that includes actual measurement control information for obtainment of the actual measurement information, predicted measurement control information for obtainment of the predicted measurement information, and an order of the rate of change information, wherein the order is a derivative order.

17. The method of claim 16, further comprising:
transmitting capability information that indicates a measurement capability of the network entity, wherein at least one of: the actual measurement control information, the predicted measurement control information, or the order of the rate of change information is based on the capability information.

18. The method of claim 14, further comprising:
obtaining, during the second duration, additional actual measurement information indicative of at least on of: the serving beam during the first duration or the candidate beam during the first duration; and
updating at least one of:
actual measurement control information for obtainment of second actual measurement information,
predicted measurement control information for obtainment of second predicted measurement information, or
an order of the rate of change information based on a difference between the additional actual measurement information and the predicted measurement information.

19. The method of claim 14, further comprising:
receiving control information that indicates at least one of: a first scaling factor associated with the actual measurement information or a second scaling factor associated with the predicted measurement information, wherein the rate of change information is based on at least one of: the first scaling factor or the second scaling factor.

20. A non-transitory computer-readable medium having code for wireless communication stored thereon that, when executed by a network entity, causes the network entity to:
detect an occurrence of an event associated with a serving beam of a serving cell or a candidate beam of a candidate cell;
obtain, based on the occurrence of the event, actual measurement information indicative of at least one of: the serving beam during a first duration or the candidate beam during the first duration; and
transmit report information based on the occurrence of the event, wherein the report information includes at least one of: rate of change information associated with the actual measurement information or predicted measurement information, wherein the predicted measurement information is indicative of at least one of: the serving beam during a second duration or the candidate beam during the second duration, wherein the second duration is after the first duration.
